(19) United States
(12) Patent Application Publication
(10) Pub. No.: US 2024/0110888 A1
(43) Pub. Date: Apr. 4, 2024

(54) METHOD FOR REMOTE CONTROL OF AN APP FOR MEASURING, CALIBRATING, AND/OR ADJUSTING A SENSOR

(71) Applicant: Endress+Hauser Conducta GmbH+Co. KG, Gerlingen (DE)

(72) Inventors: André Lemke, Schluchse (DE); Bo Ottersten, Regensburg (DE); Alexander Schwalbe, Pforzheim (DE); Jutta Paulus-Neues, Reutlingen (DE)

(21) Appl. No.: 18/477,702

(22) Filed: Sep. 29, 2023

(30) Foreign Application Priority Data
Sep. 29, 2022 (DE) 10 2022 125 246.9

(51) Int. Cl. G01N 27/416

(52) U.S. Cl. CPC G01N 27/4165; G01N 27/4167

(57) ABSTRACT

A method for remote control of an app for measuring, calibrating, and/or adjusting a sensor in process automation technology includes connecting the sensor to a handheld measuring device having at least one operating button; establishing a data connection from the handheld measuring device to a mobile device, wherein an app is executed on the mobile device; actuating the operating button and transmitting the function or data stored in the operating button to the app of the mobile device via the data connection; and processing the function or data in the app.

### CROSS-REFERENCE TO RELATED APPLICATION

The present application is related to and claims the priority benefit of German Patent Application No. 10 2022 125 246.9, filed on Sep. 29, 2022, the entire contents of which are incorporated herein by reference.

### TECHNICAL FIELD

The present disclosure relates to a method for remote control of an app for measuring, calibrating, and/or adjusting a sensor in process automation technology.

### BACKGROUND

Calibration in measuring technology is a measuring process for determining and documenting the deviation of a measuring device from another device or another measuring standard. In the case of sensors for measuring the pH, reference solutions are used, against which the sensor is calibrated. Adjustment is understood to be the precise adjustment by a professional procedure. It is preferably the setting of a measuring device or its display.

Handheld measuring devices are currently primarily used locally. There is rarely a connection to a software application, which runs, for instance, on a computer. If this is the case, however, synchronization, general handling, and operation often present a major challenge for the users. If, for example, handheld devices are connected to software applications, the operation is not always simple and self-explanatory, since two different instances interact with one another. If the connection to a software application exists, it has no possibility of operating the handheld devices. The operation of the device tailored to the software application presents the user with greater challenges. The user may already require two hands for the measurement or calibration setup, since he must hold the handheld measuring device with the connected sensor in one hand and a beaker with a sample or a reference solution in the other hand.

### SUMMARY

The object of the present disclosure is to simplify the calibration and adjustment of sensors.

The object is achieved by a method for remote control of an app for measuring, calibrating, and/or adjusting a sensor in process automation technology, comprising the steps of connecting the sensor to a handheld measuring device, wherein the handheld measuring device comprises at least one operating button; establishing a data connection from the handheld measuring device to a mobile device, wherein an app is executed on the mobile device; actuating the operating button and transmitting the function or data stored in the operating button to the app of the mobile device via the data connection; and processing the function or data in the app.

The present disclosure allows the user to operate the software application via local operation of the handheld measuring device. This present disclosure enables significantly simplified and more intuitive operation for the user.

One embodiment provides that the data connection be a wireless connection, in particular via Bluetooth.

One embodiment provides that the handheld measuring device comprise a display, and the data displayed on the display be transmitted to the mobile device.

One embodiment provides that the data be calibration or measurement data.

One embodiment provides that the app provide a function, and this function be assigned to the operating button, wherein this function is executed when the operating button is actuated.

One embodiment provides that the app send the function via the data connection to the handheld measuring device, and this function be assigned to the operating button.

The object is also achieved by a measuring system comprising at least one sensor; a handheld measuring device comprising a communications module, at least one operating button, and a data processing unit, which is designed to execute steps according to one of the preceding claims; and an app, which is executed on a mobile device and is designed to execute steps according to one of the preceding claims.

One embodiment provides that the handheld measuring device comprise a battery or rechargeable battery and be powered by a battery or rechargeable battery.

One embodiment provides that the handheld measuring device comprise a display.

One embodiment provides that the operating button be a physical button.

One embodiment provides that the mobile device be a smartphone or a tablet computer.

One embodiment provides that the sensor be a sensor for measuring the conductivity, oxygen, or the pH value, the pH value via an ISFET sensor, a redox sensor, or a combination thereof.

The object is also achieved by a computer program, in particular an app, comprising commands that, when the program is executed by a mobile device, cause it to execute steps of the method described above.

### BRIEF DESCRIPTION OF THE DRAWINGS

This is explained in more detail with reference to the following figures.

FIG. 1 shows the claimed measuring system.

FIG. 2 shows the handheld measuring device.

In the figures, the same features are labeled with the same reference signs.

### DETAILED DESCRIPTION

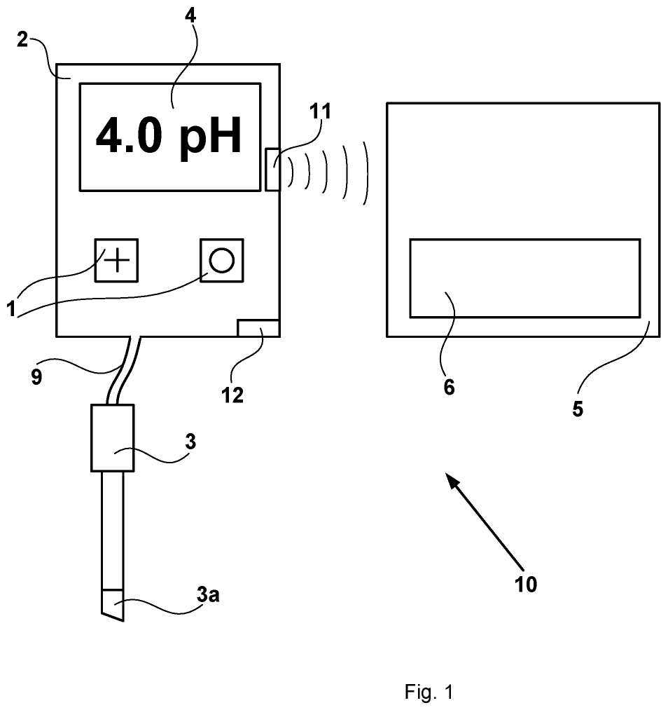

The claimed measuring system in its entirety is denoted by reference sign 10 and is shown in FIG. 1.

FIG. 1 shows a measuring system 10. A mobile device 5 can be seen. The mobile device 5 is, for example, a smartphone or a tablet computer. An app 6 runs on the mobile device 5. In general, an app 6 is application software used to process or support a useful or desired non-system functionality. The present app 6 is designed as calibration and adjustment management software.

By means of the app 6, it is possible to display the complete lifecycle of sensors—for example, of pH, redox, conductivity, and oxygen sensors. The software enables a complete traceability of test solutions, sensors, calibrations, and measurements. In addition, the sensor state evaluation helps to reduce storage costs, since users can estimate early when they have to replace the sensor.

The app 6 comprises, for example, four basic functions, viz., “measuring” (measurement including measurement graph and sample description), “calibration/adjustment” (via several calibration methods and test equipment management), “sensors” (settings, parameters, management, status, and information), and “reports” (database view, report generation, and export function).

During calibration and/or adjustment, the app 6 comprises an initiated step-by-step calibration/adjustment with clear handling instructions, test device management with pre-stored values for the buffer solutions most frequently available on the market (pH sensors), live graph for visual monitoring during the calibration-enabled evaluation of the sensor state, an adaptable stability criteria for measurement performance optimized to different requirements, and a report of information on the sensor performance and the consistency of the ongoing process.

In the case of the basic function, “sensors,” the following takes place, for example, with time stamps of adjustment and deactivation (with justification): a documentation of the entire sensor lifecycle, an assignment to the measurement point already in the laboratory, a determination of the calibration method for predictable and efficient work, an operating hours counter for evaluation of the sensor state, a check of the sensor calibration validity, a determination of intervals for the calibration and adjustment of sensors, and an alarm and warning messages informing about upcoming calibration and adjustments.

The measuring system 10 comprises one or more sensors 3; see above.

The measuring system 10 comprises a handheld measuring device 2. First, the sensor 3 is connected to the handheld measuring device 2. The handheld measuring device 2 can be designed as a measuring transducer. A measuring transducer is also called a transmitter is, generally speaking, a device that converts an input variable into an output variable according to a fixed relationship. The raw measured values from the sensor 3 are processed in the measuring transducer, e.g., averaged or converted by means of a calibration model computation model to another variable—for example, the process variable to be determined - and possibly transmitted, as in the present case to a mobile device 5; see below. A wide variety of sensors can be connected to the mobile device 2. Under the aforementioned name, “Memosens,” the applicant markets sensors for measuring pH value, conductivity, oxygen, turbidity, and other things.

The sensor 3 and its connection to the handheld measuring device 2 will now be briefly discussed. The handheld measuring device 2 comprises a data processing unit 12 with a memory. The handheld measuring device 3 comprises at least one operating button 1; two are shown. The operating button 1 is, for example, a physical button. The device 3 comprises a display 4. The display 4 can be designed as a touch display, so that the operating button can basically also be part of the touch display. For example, calibration or measurement values are shown on the display. The handheld measuring device 2 is operated by a battery or rechargeable battery. The handheld measuring device 2 comprises a communications module 11, e.g., a wireless module - for example, a Bluetooth module. By means of this, data can be sent or received, for example, by the mobile device 5; see below.

The sensor 3 comprises a first physical interface, via which the sensor is connected to the handheld measuring device 2 and thereby exchanges data (bi-directionally) and is supplied with energy (uni-directionally). The sensor 3 is connected to the handheld measuring device 2 via a cable 9. The cable 9 is part of a connection element, which can be connected at one end to the handheld measuring device 2 and at the other end to the sensor 3. At the sensor-side end, the cable 9 has a second physical interface complementary to the first physical interface. The two physical interfaces are designed, for instance, as galvanically-isolated interfaces, and especially as inductive interfaces. These physical interfaces can be coupled together by means of a mechanical plug connection. The mechanical plug connection is hermetically sealed, such that no fluid, such as the medium to be measured, air, or dust can enter from the outside.

The sensor 3 comprises at least one sensor element 3a for detecting a measurand of process automation. As mentioned, the sensor 3 is, for example, a pH sensor, also as an ISFET, generally an ion-selective sensor, a sensor for measuring redox potential, the absorption of electromagnetic waves in the medium, e.g., with wavelengths in the UV, IR, and/or visible ranges, oxygen, conductivity, turbidity, the concentration of non-metallic materials, or the temperature with the respective measured variable.

The sensor 3 comprises a first coupling body, which comprises the first physical interface. The connection element comprises a second, cylindrical coupling body that is designed to be complementary to the first coupling body and can be slipped with a sleeve-like end portion onto the first coupling body, wherein the second physical interface is plugged into the first physical interface.

The sensor 3 comprises a data processing unit, e.g., a microcontroller, which processes the raw values, obtained by the detection hardware integrated into the sensor, of the measured variable and, for instance, converts them into another data format. The data processing unit of the sensor 3 is, for energy and space reasons, designed to usually be rather small or economical with respect to the computing capacity and the memory volume. It is therefore often only intended for “simple” computing operations—for example, for digital conversion, pre-processing, and averaging. The data processing unit of the sensor 3 converts the value that is a function of the measured variable (i.e., the measurement signal of the sensor element 3a) into a protocol that the handheld measuring device 2 can understand.

To execute the method, the sensor 3 and the handheld measuring device 2 are first connected as described above.

A data connection is then established from the handheld measuring device 2 to the mobile device 5 or to the app 6.

If the operating button 1 is now actuated, the function or data stored in the operating button are transmitted to the app 6 of the mobile device 5 via the data connection 7. As mentioned above, calibration or measurement data can be shown on the display 4. The data that are currently shown on the display can be transmitted.

Finally, the function or the data in the app 6 are processed, which will be explained in detail below. In general, the app 6 can dynamically define the response to operating button 1. Thus, the function or device operation can be freely defined according to the current calibration or measurement scenario. The app 6 can also assume control of the screen and name these functions according to the state, e.g., “Save” or “Continue,” etc.

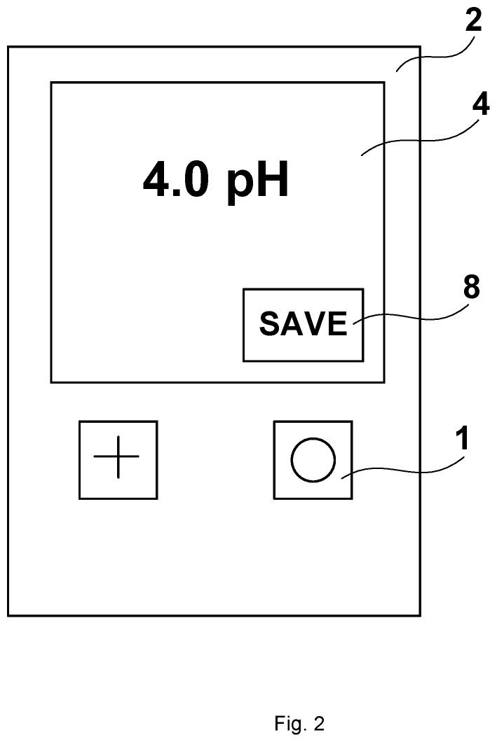

FIG. 2 shows the handheld measuring device 2 with the display 4 and a function 8. The function 8 can already be implemented on the handheld measuring device 2 from the start.

In one embodiment, the app 6 provides one or more function 8, wherein this function 8 is assigned to the operating button 1, and this function 8 is executed when the operating button 1 is actuated. Such a function 8 can, for example, be that of saving a measured value (“save”; see FIG. 2). When the button 1 is pressed, the current measured value, which may also be shown on the display, is thus transmitted via the data connection 7 to the mobile device 5 or the app 6.

Another example is performing a calibration controlled by the app 6, as described above. Then, by pressing the operating button 1, a corresponding step of the calibration is performed.

The app 6 can send the function 8 to the handheld measuring device 2 via the data connection 7, wherein the function is then assigned to the operating button.

Finally, a short summary: The app 6 runs on the mobile device 5 (smartphone/tablet). The app 6 or the mobile device 5 is connected wirelessly 7 to the handheld measuring device 2. The handheld measuring device 2 has at least one operating button 1 and a screen 4. The app 6 is able to transmit functions 8 to the handheld measuring device 2 and to receive screen contents via Bluetooth 7 or similar communications protocols. The information of the activated operating buttons 1 of the handheld measuring device 2 is transmitted to the app 6. Thereby, the app 6 can be remotely controlled by the handheld measuring device 2. The functions 8 provided by the app 6 can then be operated with the physical operating buttons 1.

The present disclosure combines the advantages of local device operation with the advantages of a connected software application in the background. After successful connection of the app 6 to the respective handheld measuring device 2, measurements or calibrations can be started. In the area of the measurements, the customer can use the handheld measuring device 2 directly and store the current measured value in the connected app 6 by pressing a key on the device. In this case, the user can concentrate on the measurement installation, and the app 6 is connected “in the background.”

1. A method for remote control of an app for measuring, calibrating, and/or adjusting a sensor in process automation technology, the method comprising:
connecting the sensor to a handheld measuring device, wherein the handheld measuring device includes at least one operating button;
establishing a data connection from the handheld measuring device to a mobile device, wherein the app is executed on the mobile device;
actuating the at least one operating button and transmitting a function or data stored in the at least one operating button to the app of the mobile device via the data connection; and
processing the function or data in the app.

2. The method according to claim 1,
wherein the data connection is a wireless connection.

3. The method according to claim 1,
wherein the handheld measuring device includes a display, and data displayed on the display are transmitted to the mobile device.

4. The method according to claim 1,
wherein the data stored in the at least one operating button are calibration or measurement data.

5. The method according to claim 1,
wherein the app provides a function, and this function is assigned to the operating button, wherein this function is executed when the operating button is actuated.

6. The method according to claim 5,
wherein the app sends the function to the handheld measuring device via the data connection, and this function is assigned to the operating button.

7. A measuring system, comprising
at least one sensor;
a handheld measuring device, including: a communications module; at least one operating button; and a data processing unit; and
an app, which is executed on a mobile device,
wherein the data processing unit is configured to transmit a function or data stored in the at least one operating button to the app of the mobile device when the at least one operating button is actuated, and
wherein the app is configured to process the function or the data transmitted by the data processing unit.

8. The measuring system according to claim 7,
wherein the handheld measuring device includes a battery or a rechargeable battery and is powered by the battery or the rechargeable battery.

9. The measuring system according to claim 7,
wherein the handheld measuring device includes a display.

10. The measuring system according to claim 7,
wherein the operating button is a physical button.

11. The measuring system according to claim 7,
wherein the mobile device is a smartphone or a tablet computer.

12. The measuring system according to claim 7,
wherein the sensor is a sensor for measuring conductivity, oxygen, or the pH value, the pH value via an ISFET sensor, a redox sensor, or a combination thereof
